(19) United States
(12) Patent Application Publication
(10) Pub. No.: US 2025/0139499 A1
(43) Pub. Date: May 1, 2025

(54) PRIVACY-PRESERVING ROBUST DOMAIN ADAPTATION IN EDGE ENVIRONMENTS

(71) Applicant: Dell Products L.P., Round Rock, TX (US)

(72) Inventors: Vinicius Michel Gottin, Rio de Janeiro – RJ (BR); Paulo Abelha Ferreira, Rio de Janeiro – RJ (BR); Pablo Nascimento da Silva, Niterói – RJ (BR)

(21) Appl. No.: 18/496,399

(22) Filed: Oct. 27, 2023

(51) Int. Cl. G06N 20/00

(52) U.S. Cl. CPC G06N 20/00

(57) ABSTRACT

One example method includes by a central node configured to communicate with edge nodes, determining subsets of the edge nodes, by the central node, splitting a distillation process for each of the subsets of the edge nodes to generate distilled datasets, by the central node, leveraging the distilled datasets to adapt a base machine learning (ML) model for use at a newly deployed edge node that lacks adequate data to adapt the base ML model, and deploying, by the central node, the base ML model, after adaptation, to the newly deployed edge node.

### FIELD OF THE INVENTION

Embodiments of the present invention generally relate to deployment and use of ML (machine learning) models at one or more edge nodes. More particularly, at least some embodiments of the invention relate to systems, hardware, software, computer-readable media, and methods, for adaptation and deployment of a baseline ML model at a newly deployed edge node.

### BACKGROUND

Performing ML tasks at the edge requires handling massive amounts of data and dealing with thousands, or even millions, of smart nodes running training and inference of models. In some scenarios, such as autonomous self-driving vehicles for example, an environment may comprise thousands or millions of edge nodes, each one with its own large data stream of particular duration and dimensionality.

While a federated approach might be employed to obtain a baseline model, for example, each edge node E must still perform its own local domain adaptation process to the baseline model. Besides being costly for all nodes, this process is not applicable in all cases. For newly deployed nodes which do not have sufficient local data, such an approach may not be feasible.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example algorithm for dataset distillation.

FIG. 2 discloses a table of symbols relating to the algorithm of FIG. 1.

FIG. 3 discloses an example algorithm for Decentralized Federated Dataset Distillation (DFDD).

FIG. 4 discloses an example algorithm for Iterative Robust Federated Dataset Distillation (IR-FDD).

FIG. 5 discloses an edge environment with a central node, and edge nodes.

FIG. 6 discloses an example method for implementing Specialized Iterative Federated Dataset Distillation (SI-FDD).

FIG. 7 discloses a comparison of examples of IR-FDD and SI-FDD.

FIG. 8 discloses various stages of an example SI-FDD method.

FIG. 9 discloses various further stages of an example SI-FDD method.

FIG. 10 discloses an example method for Specialized Robust Aggregation.

FIG. 11 discloses an example method for determining possibly divergent nodes.

FIG. 12 discloses an example method for domain adaptation and model selection of a new edge node.

FIG. 13 discloses an example computing entity configured and operable to perform any of the disclosed methods, steps, processes, and operations.

### DETAILED DESCRIPTION OF SOME EXAMPLE EMBODIMENTS

Embodiments of the present invention generally relate to deployment and use of ML (machine learning) models at one or more edge nodes. More particularly, at least some embodiments of the invention relate to systems, hardware, software, computer-readable media, and methods, for adaptation and deployment of a baseline ML model at a newly deployed edge node.

One example embodiment of the invention is directed to a method, which may be cooperatively implemented by a central node and one or more edge nodes. Parts of the method may be performed only at the central node, and other parts of the method may be performed only at an edge node, or edge nodes.

In an embodiment, the method comprises determining subsets of edge nodes that are consistently disregarded in a robust aggregation operation, and splitting a distillation process for each current known set. This process yields a number of distilled datasets ˜x1, ˜x2, . . . , each from a respective set of edge nodes. Each of the distilled datasets may have characteristics of generality for the associated set of edge nodes, and coherence, such as with respect to drift, malicious attacks or other deviations. The method may then leverage multiple such robust distilled datasets to perform a specialized domain adaptation process of a base ML model M when a new edge node, which may have little significant local data available for such an adaptation, is deployed. This domain adaptation includes a process to evaluate and choose the adaptation, using one the distilled datasets, that most benefits the ML model M, such as in terms of the ease and speed of training of that ML model M.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an advantageous aspect of one embodiment of the invention is that a bootstrap ML model at a newly deployed edge node may be trained at the edge node without necessitating to the use data local to the edge node. In an embodiment, a bootstrap ML model at a newly deployed edge node may be trained at the edge node in a way that is tuned to the particular operations of that edge node. An embodiment may implement fine tuning of a bootstrap ML model at a newly deployed edge node, based on data and operations associated with other edge nodes, while also preserving the privacy of the data of the various nodes. An embodiment may reduce a processing load on a newly deployed edge node by performing various operations related to the tuning of a bootstrap ML model at a central node instead. Various other advantages of one or more example embodiments will be apparent from this disclosure.

It is noted that embodiments of the invention, whether claimed or not, cannot be performed, practically or otherwise, in the mind of a human. By way of illustration, while the disclosure refers to operations that may be performed at and/or in conjunction with one or more edge nodes, such operations may in fact be performed for thousands, or more, edge nodes on an ongoing basis. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for an Example Embodiment

The following is a discussion of aspects of a context for an embodiment of the invention. This discussion is not intended to limit the scope of the invention, or the applicability of the embodiments, in any way.

### A..1 Dataset Distillation

Dataset Distillation is a recent research area where techniques are being developed to obtain a much smaller dataset that is still able to train an ML model to reasonable accuracy. An aim of dataset distillation is to find an answer to the question-What would be a small synthetic dataset that when used to train a model, would yield low error? Thus, dataset distillation (DD) is not necessarily concerned with obtaining a small sample of a dataset, nor necessarily interested in a compression of the full dataset. Rather, DD may be thought of as being directed to the idea of building a sketch, that is, a distilled dataset, of the data in order to approximate a function, that is, an ML model.

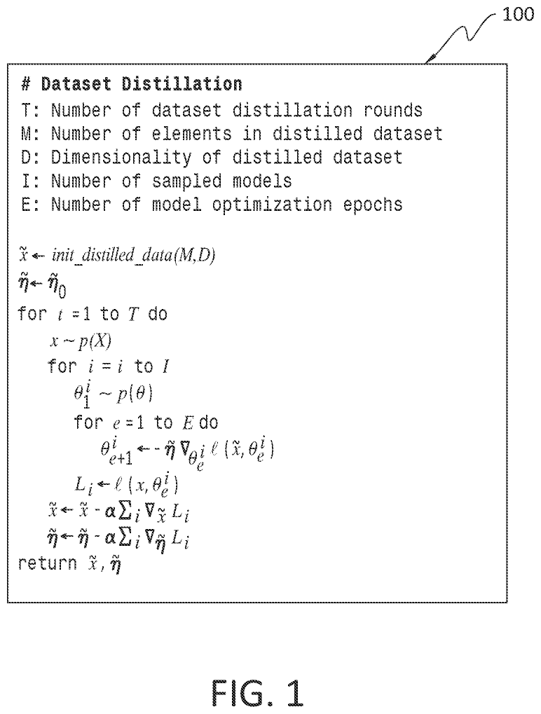

A distilled dataset may be obtained through the use of a double optimization process, beginning with a synthetic random dataset, such as white noise images for example, optimizing an ML model, or simply “model,” with a known real dataset, calculating a loss on the current synthetic dataset, and the optimizing with respect to the synthetic dataset on this calculated loss. Many different models in this optimization process may be sampled in order to obtain a distilled dataset that is robust to in-distribution changes to a family of models. Further information regarding DD processes is disclosed in “T. Wang, J. Zhu, A. Torralba and A. Efros, ‘Dataset distillation,’ arXiv, vol. preprint arXiv: 1811.10959., 2018.” (“Wang”), incorporated herien in its entirety by this reference. Following is a discussion of a DD algorithm, identified at 100 in FIG. 1.

In a DD process, the algorithm 100 may run for T training rounds and involve four operations, namely:
[1] distilled dataset initialization;
[2] model optimization;
[3] distillation gradient computation; and
[4] distillation optimization.

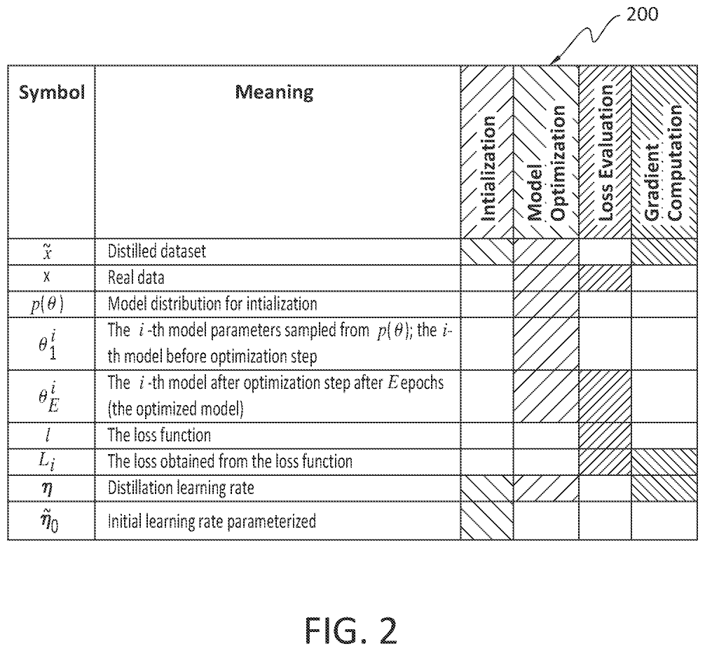

These operations are highlighted in FIG. 1, and represented in a table 200, in FIG. 2, of symbols with corresponding indications. The table 200 also indicates in which operations each object/concept is relevant and/or required.

### A.2 Decentralized Federated Dataset Distillation (DFDD)

In “U.S. patent application Ser. No. 17/451,608, filed Oct. 20, 2021, titled “ADAPTABLE DATASET DISTILLATION FOR HETEROGENEOUS ENVIRONMENTS”” (“ADDHE”), incorporated herein in its entirety by this reference, there is defined a framework for adaptable dataset distillation, which determines a set of alternative algorithms for dataset distillation based on environment constraints. Each algorithm performs the steps in the dataset distillation process in different combinations of central node and edge nodes, and incurs in distinct computation, communication and memory requirement profiles.

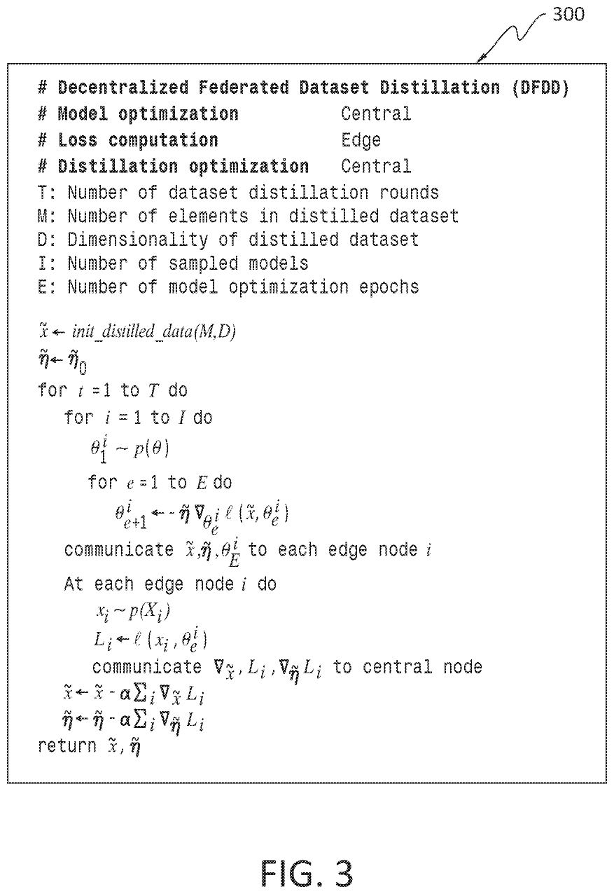

One such algorithm, denoted at 300 in FIG. 3, is the Decentralized Federated Dataset Distillation (DFDD), which may be used in scenarios in which edge nodes are resource constrained and where there is also a need for keeping the data private across nodes. The algorithm 300 comprises an alternative form of a transfer of ∇_{\tilde{x}}Lᵢ, ∇_{\tilde{η}}Lᵢ; from the edge to the central node.

In method of the algorithm 300, each edge node receives one optimized model for loss evaluation in a distillation round t. The edge nodes also receive the current distilled dataset and learning rate for that computation. As explained in further detail below, one embodiment of the method extends and adapts this approach with a mechanism for applying a robust aggregation approach to sets of updates resulting from the computation at the edge nodes.

### A.3 Iterative Robust Federated Dataset Distillation (IR-FDD)

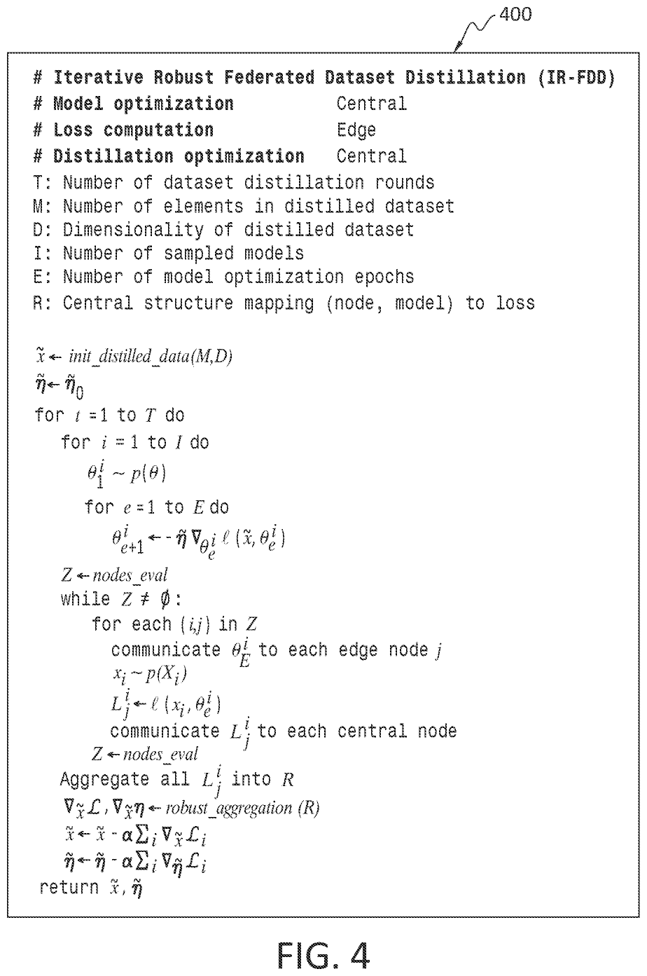

In “U.S. patent application Ser. No. 18/157,966, filed Jan. 23, 2023, titled ROBUST AGGREGATION FOR FEDERATED DATASET DISTILLATION” (“IR-FDD”), incorporated herein in its entirety by this reference, there is defined a method for robust aggregation in distributed dataset distillation approaches. That method involves the concept of Robust Aggregation (RA) for the management of updates to a distilled dataset during training and the relevant changes in aspects of communication between central node and edge nodes entailed. An algorithm for this approach is referenced at 400 in FIG. 4, and identified as IR-FDD (iterative robust federated dataset distillation).

By way of contrast with DFDD, the IR-FDD algorithm 400 includes:
additional orchestration for determining which nodes receive which models for evaluation, lifting the restriction of 1:1 nodes to models;
a more restricted set of communication parameters-so that less data traverses through the network between edge nodes and central node; and
a robust aggregation step to determine which loss evaluations are to be considered for the gradient computation step.

The IR-FDD algorithm 400 encapsulates this last process into a function called robust_aggregation that will calculate the gradients and filter those gradients for robustness. The definition of the robust aggregation is as follows:

The central node has all the θ_{E}ⁱ trained model which it can combine with each node-model loss to obtain the corresponding loss and learning rate gradient for node i and model j: ∇_{\tilde{x}} [symbol] ᵢ^{j} and ∇_{\tilde{Λ}} [symbol] ᵢ^{j}. In other words, for every trained model, both gradients are obtained for all nodes that assessed that model.

The next step is for each node to average all its loss and learning rate gradients. That is, calculating average loss gradient thus:

$${∇}_{\tilde{x}} {\overline{ℒ}}_{ι} = \frac{1}{\vert M \vert} {\sum }_{j ∈ M} {∇}_{\tilde{x}} {ℒ}_{i}^{j}$$

and, calculating average learning rate gradient thus:

$${∇}_{\tilde{η}} {\overline{ℒ}}_{ι} = \frac{1}{\vert M \vert} {\sum }_{j ∈ M} {∇}_{\tilde{η}} {ℒ}_{i}^{j}$$

for each node i and its assessed models M.

This approach will result in two lists ∇_{\tilde{x}} [symbol] and ∇_{\tilde{Λ}} [symbol] , with one element per node. We feed the averaged gradients ∇_{\tilde{x}} [symbol] to a robust aggregation function that will compute a final aggregated gradients that considers only valid gradients. These are gradients considered to be “inside the distribution”. This is similar to the concepts in robust aggregation as applied to federated learning environments—to ensure that only reasonable gradients are considered prior to final averaging. One example of a robust aggregation function would be to only consider gradients that e standard deviations away from the mean gradient. Other examples include other outlier measures.

### A.4 Environment and Constraints

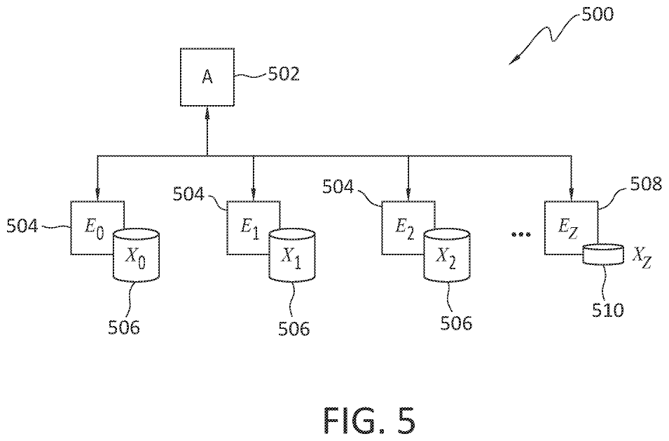

One embodiment may assume an edge environment 500, as disclosed in FIG. 5, with a central node 502, such as at the core or cloud for example, and a multiple edge nodes 504 E₀, E₁, . . . , wherein respective local datasets 506 X₀, X₁, . . . are collected. One of these nodes 504 or another suitable computational infrastructure may be defined to be the central node 502 A. The nodes 504 of the edge environment 500 may have respective have locally available data. The local datasets 506 may not be identically distributed and must be kept private from other edge nodes 504. A newly deployed edge node 508 E_{z} is represented with a locally available dataset 510 X_{z} that is substantially smaller than any of the datasets 506. That is, the locally available dataset 510 X_{z}, by virtue of its relatively small size, may be incomplete for the training of the ML model local dataset X_{z}. A communication layer between the central node 502 and edge nodes 504/508 may be assumed to be in place.

With continued reference to the example of FIG. 5, one approach may be to provide newly deployed edge node 508 E_{z} with a bootstrap version of a model, which can then be adapted or fine-tuned with local data as it becomes available. In this approach, that model may be trained at one of the other edge nodes 504 Eᵢ. However, there is no guarantee that the local datasets 506 X₀, X₁, . . . , and the still partially or completely unavailable dataset 510 X_{z}, are subject to the same underlying distribution. Hence, a model trained with data from multiple edge nodes may be preferable. One alternative for such cases is the application of a DD process in which multiple nodes contribute to the composition of a single distilled dataset. This single distilled dataset may enable the training of a model to a similar level of accuracy, as if the model had been trained with a much larger dataset of original source data, while being orders of magnitude smaller than the original source data.

### B. Overview of an Example Embodiment

One example embodiment extends and adapts an approach leveraging Robust Aggregation (RA) by determining subsets of edge nodes that are consistently disregarded in the robust aggregation step, and splitting the distillation process for each current known set. This process yields a number of distilled datasets ˜x1, ˜x2, . . . , each from a respective set of edge nodes, and with characteristics of generality, for that set of edge nodes, and coherence with respect to drift, malicious attacks or other deviations.

An embodiment may then leverage multiple such robust distilled datasets to perform a specialized domain adaptation process of a base ML model M when a new edge node, which may have a negligible amount of relevant local data, is deployed. This domain adaptation may comprise a process to evaluate and choose the adaptation, using one the distilled datasets, that most benefits the model M.

Among other things then, an embodiment may comprise a process for specialized robust aggregation for dataset distillation, and an approach for the orchestration of multiple robust distilled datasets for domain adaptation of baseline model at a newly deployed edge node. An embodiment may comprise various other functionalities and aspects as well, examples of which are disclosed herein.

### B.1 Example Features and Aspects of an Embodiment

One embodiment may be directed to a method that comprises providing robust bootstrapped machine learning models in edge environments with data privacy concerns. One aspect of an embodiment concerns bootstrapping machine learning models at the edge.

An embodiment may operate to efficiently deploy models to dynamically added edge nodes, where efficiency concerns the amount of data needed to be stored for training and the required time for fine-tuning at the edge. An embodiment may thus operate to save costs and communication overhead by reducing pre-deployment training and fine-tuning training at the edge, which also enables fine-tuning in low-compute edge devices.

To this end, an embodiment may employ a distributed dataset distillation as a way to obtain a, possibly very, small dataset, cheap to communicate, and which allows the training of bootstrap models at newly deployed edge nodes. In so doing, an embodiment may effectively deal with challenges concerning, for example, data scalability and model generality.

For example, to ensure the generalization capabilities of ML models, an embodiment may ensure that representative data is obtained for the training process. In the distributed dataset distillation scenario, an embodiment may operate to obtain representative data from as many nodes as possible. In circumstances where there may be no assurance of homogeneity in the distributions of the data collected at the edge nodes, that is, the assumption of independent and identically distributed data does not hold for the domain, a trade off may present itself, as adding more nodes to the distillation process increases the chance that differently distributed data will be acquired, but increasing the number of nodes may also affect resource consumption and time to deployment of the ML model.

Another challenge that may be effectively dealt with by an embodiment concerns malicious interference in distributed dataset distillation. Particularly, an embodiment may address the circumstance where a distributed dataset distillation process is the target of malicious interference, with one or more nodes arbitrarily adopting/communicating erroneous or ‘poisoned’ updates.

### C. Detailed Discussion of Aspects of an Example Embodiment

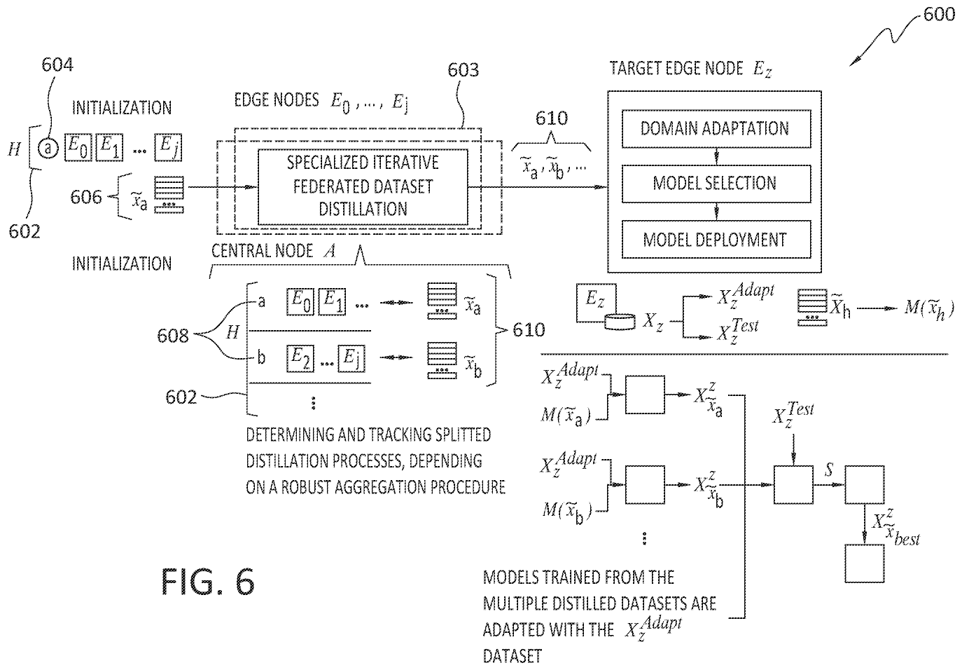

One example embodiment comprises a method to orchestrate multiple distilled datasets, extending and adapting the IR-FDD approach, referenced earlier herein, and then leveraging these multiple distilled datasets for a domain adaptation and model selection process at the target edge node E_{z}. An overview of this approach, referenced at 600, is disclosed in FIG. 6. Particularly, FIG. 6 discloses two stages, namely, [1] the obtaining of multiple distilled datasets in federated fashion, and [2] the deployment of a chosen model, via a domain adaptation and selection approach, at the target node E_{z}.

In more detail, a structure 602 H is initialized so that all available edge nodes 603 0, . . . , j are initially considered part of the same set 604 a. A single corresponding distilled dataset 606 \tilde{x}ₐ is generated. As the SI-FDD process progresses, this set 604 a may be ‘split’ into multiple subsets 608 a, b, . . . . As part of this federated dataset distillation process, separate dataset distillation process may be performed for each existing subset, which may, in turn, split yet again in a future cycle. This federated dataset distillation process may then yield multiple resulting distilled datasets 610 \tilde{x}ₐ, \tilde{x}_{b}, . . . , each corresponding to a respective subset of nodes Hₐ, H_{b}, . . . , as determined by a robust aggregation approach. The aforementioned stages are addressed in further detail below.

### C.1 Specialized Iterative Federated Dataset Distillation (SI-FDD)

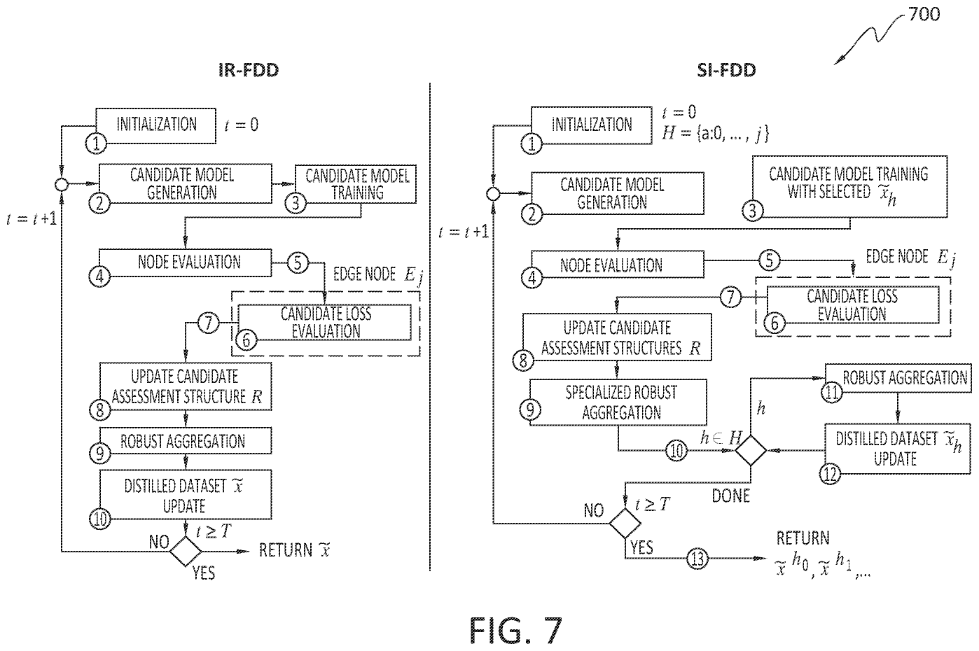

The first stage of one embodiment comprises an adaptation of the IR-FDD, where this adaptation, denoted at method 700, may be referred to herein as Specialized Iterative Federated Dataset Distillation (SI-FDD), aspects of which are disclosed at the right side of FIG. 7, while the method at the left side of FIG. 7 is provided as a comparative example.

In general, the SI-FDD approach, according to one embodiment, may comprise the following aspects:
a specialized robust aggregation step which splits the current sets of available edge nodes into subsets, depending on the results of the robust aggregation for the sets;
a separate robust aggregation step for each set of nodes, resulting in distinct updates to the distilled dataset for each subset; and
the adaptation of the training cycle to account for the multiple distinct distilled datasets.

### C.1.1 Initialization and Candidate Generation Steps

The first operations, referred to as ‘steps’ in the Figures for ease of reference, of the example method 700 comprise the initialization of the training process, namely, Step 1, and the early stages in each distillation loop, namely, Steps 2 and 3 respectively directed to candidate generation and training, and Steps 4, 5, 6 and 7, which generally concern the loss evaluation of those candidates at selected nodes. Further details concerning these Steps are set forth below.

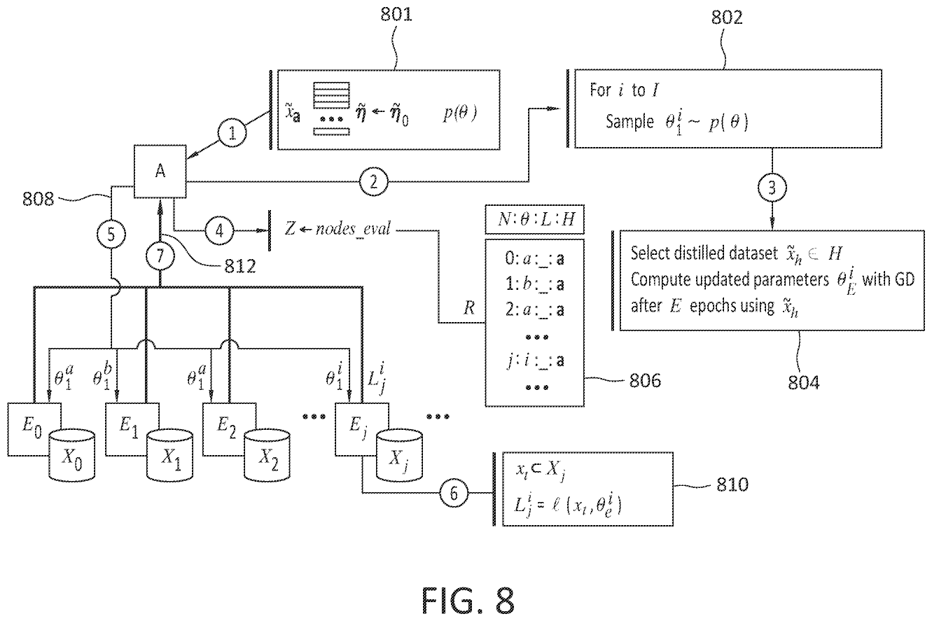

In particular, and with reference now to FIG. 8, that Figure discloses Steps 2-7, in which separate distilled datasets are available for subsets a and b of the edge nodes. In an embodiment, Step 1, which may comprise an initialization of a main loop of a dataset distillation process of the SI-FDD, may be similar to Step 1 of IR-FDD (see FIG. 7).

In particular, and as best shown in FIG. 8, and with continued attention to FIG. 7, initialization process of Step 1 begins with a definition of the initial learning rate ñ₀, a single randomly initialized distilled dataset 801 \tilde{x}ₐ, and the definition of the weight distributions for all the training models p(θ).

Step 2 comprises the start of a dataset distillation loop. In an embodiment, Step 2 of SI-FDD may be identical to the corresponding step in IR-FDD. In Step 2, the central node samples weights θ₁ from p(θ), determining an initial version of a model. In the notation adopted, these weights are indexed by i, that is, the index of the sample in the set of models, as shown at 802.

In Step 3, for each such sample of weights, an embodiment may perform 804 a training iteration of E epochs which adjusts the weights θ₁ⁱ obtaining θ_{E}ⁱ. Note that, by way of contrast with an embodiment, the IR-FDD training approach is performed with respect to the single distilled dataset %, and hence does not require real data. On the other hand, in the SI-FDD approach, according to one embodiment, there may be only a single distilled dataset at the start, but in later iterations of the loop, that is, when t>1, there may be multiple distilled datasets \tilde{x}ₕ because of the specialized robust aggregation undertaken in Step 9, discussed below.

Thus, the Step 3 of FIG. 8 additionally comprises, relative to IR-FDD, selecting a distilled dataset \tilde{x}ₕ to perform the training. In an embodiment, this selection may employ a structure H that maps which edge nodes are currently associated to which respective subsets. Recall that the structure H may be initialized assigning all nodes to a same subset, and may be updated as part of Step 9. In one particular example embodiment, each initial candidate model may be trained with each distilled dataset \tilde{x}ₕ. Other selection approaches may be feasible, but additional structures and orchestration may be required to track which candidate models were trained with which dataset, for the next step.

With continued attention to FIG. 8, Step 4 is a decision process for determining which nodes receive which models for evaluation. This procedure may rely on tracking, by the central node, of characteristics of the edge nodes, such as the expected response times by the edge nodes, their resource availability, and their data availability. As in the IR-FDD approach, an embodiment may determine a tracking structure 806 R that annotates which models have been evaluated at each edge node.

In an embodiment, each entry (j, i, l, h) in the structure R may comprise:
j: the index {0, 1, . . . j} of an edge node Eⱼ in the environment;
i: the identifier of a trained candidate model-formally, each model would be θ_{E}ⁱ, representing the i-th initial candidate model trained for E epochs—for ease of notation these models are denoted a, b, . . . ;
l: a loss Lⱼⁱ, meaning the loss obtained by evaluation model i at node j; and
h: the subset of edge nodes {a, b, . . . } ∈H the node j is currently assigned to—this is added to structure R to facilitate the tracking of which models are related to each subset of edge nodes—it is noted that, in an embodiment, this may not be strictly necessary, since an embodiment may track models to nodes and nodes to subsets, using the structure H.

In an embodiment, this selection may be adapted to account for the multiple subsets h∈H of edge nodes resulting from the specialized robust aggregation, at Step 9. In an embodiment, this may comprise, for example, making sure that a representative number of nodes from each subset of nodes h are selected. This may be the only constraint added in the typical embodiment of Step 3. In any case, a candidate model trained with distilled dataset \tilde{x}ₕ may only be deployed to edge nodes in subset Hₕ of the edge nodes. In an embodiment, Steps 5, 6 and 7 may be identical to the same steps IR-FDD approach and are included for completeness of explanation.

With continued reference to the example of FIG. 8, in Step 5, the many resulting trained model weight samples OF are communicated 808 to the edge nodes, which were selected in Step 4, such that each trained model weights sample θᵢ^{E} is sent to a set of nodes for loss evaluation. An embodiment may include the constraint that a same model should be sent to a same subset of nodes in H.

Next, and referring again to FIG. 8, at Step 6, each edge node Eⱼ performs 810 loss evaluation, that is, an assessment of the optimized model that resulted from the training performed as part of Step 2, against real data xₜ⊂Xᵢ. Both the model architecture, so that the weights θ₁ may be instantiated into a proper model for evaluation, and the loss function l(.) must be known across all nodes, by way of any appropriate communication protocol, leveraging the in-place communication layer, as discussed above. It is noted that in FIG. 8, Step 6 is indicated for node Eⱼ only, although in an embodiment, a corresponding process takes place at each of the selected edge nodes. Next, at Step 7, each resulting loss value Lⱼⁱ is communicated 812 back to the central node ‘A.’

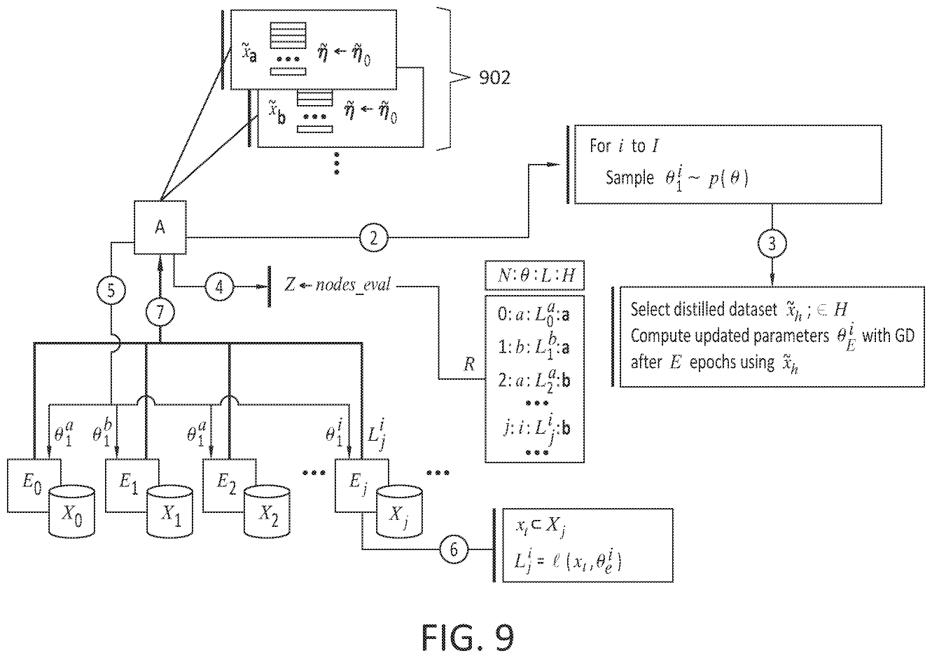

Finally, the Steps 1-7 of FIG. 9 may be identical to those of FIG. 8, except that in FIG. 9, separate distilled datasets 902 are available for subsets a and b of the edge nodes. In contrast, in the example of FIG. 8, a single distilled dataset 801 is employed.

### C.1.2 Specialized Robust Aggregation and Distilled Dataset Updates

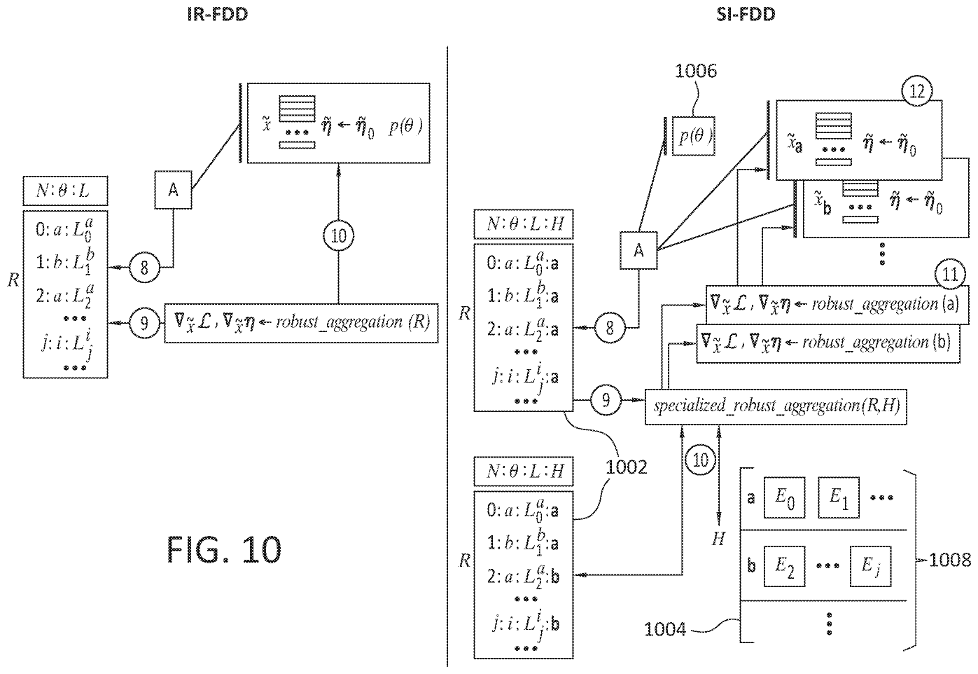

Attention is directed now to further operations, disclosed in FIG. 10, of the example training cycle according to one embodiment. In the example of FIG. 10, an embodiment determine subsets of the edge nodes that can be coherently aggregated, and then effectively split the distillation process for each of the resulting subsets. This is represented in the FIG. 10, again contrasting the steps of the IR-FDD approach (left) with those of an embodiment of an SI-FDD approach (right). In general, FIG. 10 discloses the specialized robust aggregation yielding subsets of edge nodes h₀, h₁, . . . and update of multiple corresponding distilled datasets \tilde{x}^{h}^{₀}, x^{h}^{₁}, . . . ; and the tracking of the subsets of edge nodes and models via the structures R 1002 and H 1004.

In the example of FIG. 10, the structure 1002 R is used to store the loss values obtained from the evaluations in Step 7. The structure 1002 R relates the index of an edge node 1006 {0, 1, . . . }∈N to the candidate model identifier a, b, . . . to the loss Lⱼⁱ obtained for candidate model a at node j. An embodiment may additionally relate each candidate model uniquely to a subset of edge nodes {a, b, . . . }∈H. Hence, an additional column in R 1002 may suffice. FIG. 10 represents the result of Step 8 as the initial case, in which all candidate models are associated to a single set of edge nodes a.

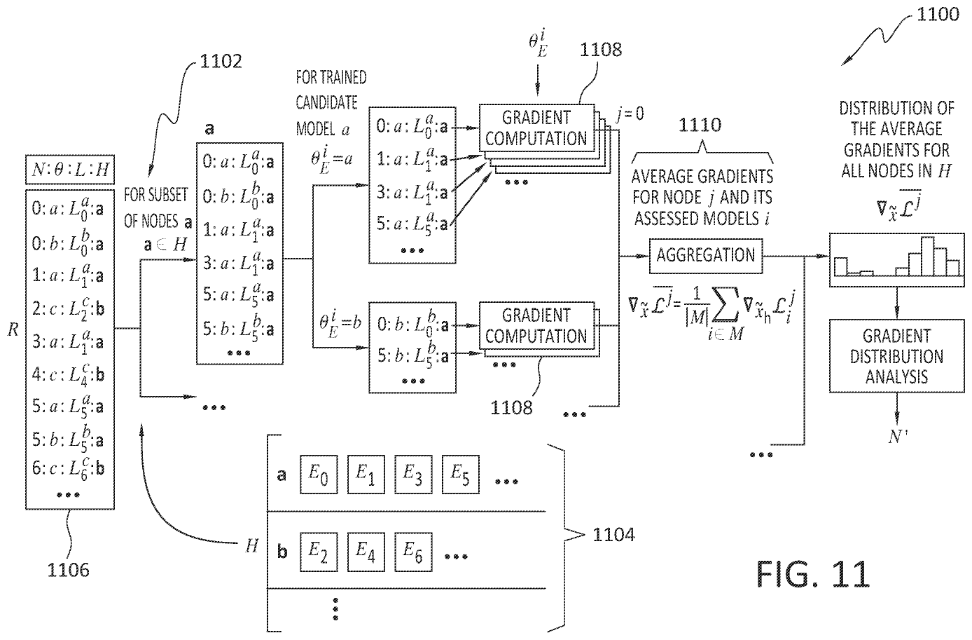

In an embodiment, the splitting of a set is determined by the specialized robust aggregation approach of Step 9. As a result of Step 9, it can be seen, in FIG. 10, that the initial set of nodes split into two subsets 1008 a and b. From then on, the training loop of the dataset distillation is effectively ‘split’ between those sets. An example embodiment of a Specialized Robust Aggregation algorithm as implemented in Step 9, is referenced at 1100 in FIG. 11, and is configured for determining the possibly divergent nodes N′ based on the distribution of the average gradients for all models evaluated at each node.

With continued reference to FIGS. 10 and 11, for each subset 1102 of nodes h∈H, an embodiment may consider the losses obtained by each candidate model associated to a node in h. Further, for each trained candidate model 1104 a, b, . . . , which may all be available at the central node, and recalling the denoting of a, b, . . . as θ_{E}ⁱ), an embodiment may combine each node-model loss in R 1106 to obtain the corresponding loss and learning rate gradient for node j and model i, that is, ∇_{\tilde{x}}_{ₕ} [symbol] ᵢ^{j} and ∇_{\tilde{η}} [symbol] ᵢ^{j}, respectively. In other words, for every trained model, an embodiment may obtain gradients for all nodes that assessed that model. In FIG. 11, only the gradient computations 1108 for the losses are presented, with the understanding that the corresponding computation for the learning rate could be similarly applied.

Next, each node may aggregate 1110 all its loss and learning rate gradients ∇_{\tilde{x}}_{ₕ} [symbol] and ∇_{\tilde{η}} [symbol] . An embodiment may assume that the average comprises a reasonable aggregation, with the observation that all models θ_{E}ⁱ are originally obtained from a same original distribution p(θ), and that may generally determine that the gradients from multiple edge nodes—if their local datasets are coherent—should be somewhat similar even for different model instances.

The Specialized Robust Aggregation process of Step 9, and as illustrated in FIG. 11, may be similar to the Robust Aggregation in Federated Learning environments and leveraged in the IR-FDD, and in Step 11 as discussed below. One difference is that IR-FDD only considers gradients that are E standard deviations away from the mean gradient to be “outliers.”

By way of contrast, an embodiment of SI-FDD may perform an analysis of gradients distribution to determine a list of nodes N′ that could be split from the current subset of nodes h. This analysis may comprise a simple thresholding from the mean, but may also comprise different kinds of analysis such as, for example, a straightforward check for a bimodal distribution is clear indication of a ‘split.’

Regardless of the Robust Aggregation method applied, an embodiment may consider the list of nodes N′ as indications for splitting. That is, an embodiment may not immediately trigger the splitting of the subset of nodes. Instead, an embodiment may feed a historical structure that keeps track of how frequently each node is found to yield diverging gradients, for example, from the mean average gradients from other nodes in the same subset, for a distilled dataset.

In that case, an embodiment may define a threshold w for nodes to be considered for splitting in an iteration t of the training loop. Notice that w may be a lower threshold than the E adopted in the Robust Aggregation function, as in IR-FDD, and leveraged in Step 11. This is because the threshold w is meant to indicate an intent to split those nodes into a separate distillation process, and not discard them, as in the IR-FDD approach.

Furthermore, the two thresholds may be used together in an embodiment—the lower threshold ω indicating the node should be considered for splitting, and the higher threshold ϵ being used to trigger an immediate split. In this way, an embodiment may allow for both immediate and “delayed” splits. With the indications for splitting collected over time, an additional assessment may then be employed to determine whether a node has been considered frequently enough. Any straightforward choice or selection algorithm for such may be applied, such as splitting nodes that are indicated n times consecutively, that is, for example, at iterations t, t+1, . . . , t+n of the distillation loop. The intended result is triggering the splitting of the subset of nodes h that node belongs to when it has been indicated multiple times.

Regardless of the approach, the splitting may trigger changes to the control structures 1104 and 1106, H and R respectively, in Step 10 (see FIG. 10). The structure 1104 H may be amended accordingly, annotating the relation between nodes and subsets. The column “H” in structure 1106 R may also be updated, reflecting those changes, since an embodiment may keep track of the relation between models evaluated and nodes in that structure.

An embodiment may assume that the splitting procedure triggers for all selected nodes in a subgroup in conjunction. That is, such an approach does not allow for ‘multiple splits’—each subset of nodes h is either kept, or split, exactly in two subsets: h′, with the nodes selected for splitting, and another with the remaining members of h, which from then on may be denoted as h, for simplicity of notation.

It is noted that while more complex methods of analysis may allow a ‘multiple split’ of a subset of nodes, the approach according to one embodiment should be sufficient to ensure the ‘quality’ and coherence of the main resulting subset. Any unsuitable subset generated may be further split in a next iteration of the distillation loop. An approach for joining two or subsets h, . . . , h′ may be implemented. This approach may involve either selecting one of the current distilled datasets \tilde{x}ₕ for continuing the training process, and discarding the others, or, a way to merge two or more of the distilled datasets \tilde{x}ₕ, . . . , \tilde{x}_{h′}.

As noted earlier, Step 11 and Step 12 may, in an embodiment, be similar to the corresponding processes in the IR-FDD approach. Depending on the implementation, the computations for the robust aggregation of a subset of nodes h in Step 11 may directly correspond to, or at least partially leverage, the results already computed at Step 9.

### C.2 Domain Adaptation and Model Selection

As an example of the usefulness of the process described above in ‘Specialized Iterative Federated Dataset Distillation,’ the process of distilling multiple datasets can be used in the training process of a model for a new edge node E_{z} that has just joined the federation. Note that a new edge node has not had the chance to collect a sufficiently good dataset for training a complete model alone, and additionally may be collecting data from a different domain than other nodes in the federation. As such, simply sharing an existing node would not be sufficient.

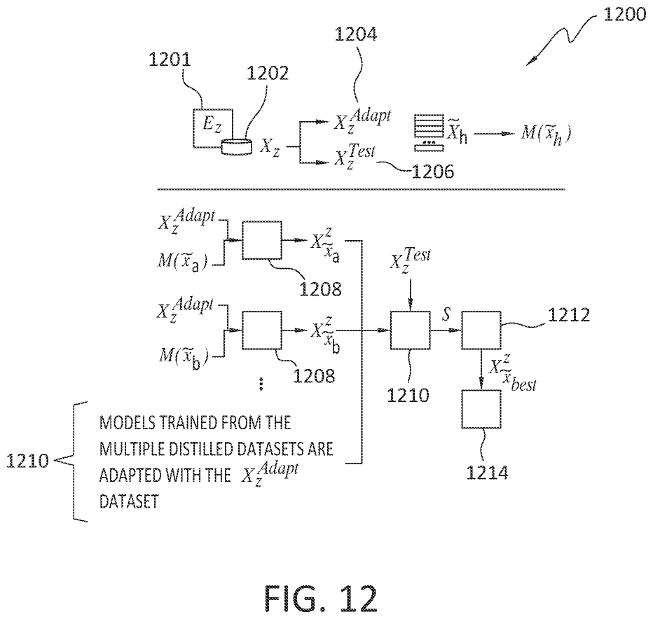

An example embodiment thus comprises a method for training and adapting a model for a new edge node, leveraging the distilled dataset and a small dataset collected by the new edge node. An example embodiment of this method is referenced at 1200 in FIG. 12 and can be divided into various operations, as explained below. Particularly, FIG. 12 discloses an example of domain adaptation and model selection for a new edge node Z joining a federation.

Initially, in the method 1200, the deployed edge node 1201 starts collecting some data from its environment. Once a target amount of data is collected, the edge dataset 1202 X_{Z} may be built, and then this edge dataset 1202 X_{Z} may be divided into two parts 1204 and 1206, respectively, X_{Z}^{Adapt} that will be used in the domain adaptation phase, and X_{Z}^{Test} that will be used in the assessment phase, to enable performance of a model selection procedure for choosing the best model trained for the new edge Z.

Next, the machine learning models 1208 may be trained 1210 using the gathered distilled datasets. For each distilled dataset \tilde{x}ₕ an embodiment may obtain a corresponding model. Then, a domain adaptation procedure may be applied to adapt the training model to also perform good in the new operating domain that edge node Z is within. The model architecture and training procedure may be defined by a specialist and do not affect the other parts of the process.

Also, the domain adaptation procedure may use any suitable method, such as a Domain Adversarial Neural Network (DANN) for example, as disclosed in “Y. Ganin and e. al., ‘Domain-adversarial training of neural networks.’, The journal of machine learning research, no. 17.1 (2016): 2096-2030.,” which is incorporated herein in its entirety by this reference.

The outcome of the domain adaptation procedure may be k different models, one from each original distilled dataset. The performance of these models is then evaluated by using the test dataset 1210 X_{Z}^{Test} generated in Step 1. The evaluation may be performed using a pre-defined evaluation metric E (model, dataset) defined by a specialist, for example, accuracy of the model, f−1 measure, or any other useful metric or combination of metrics could be used.

In an embodiment, the result of the evaluation is stored in a score vector 1212

$$S ← [ {S}_{{M}_{{\tilde{x}}_{a}}^{Z}} , {S}_{{M}_{{\tilde{x}}_{b}}^{Z}} , … ] ,$$

where each

$${S}_{{M}_{{\tilde{x}}_{a}}^{z}} = E ( {M}_{{\tilde{x}}_{a}}^{Z} , {X}_{Z}^{T e s t} ) .$$

After calculating the score of the model, an embodiment may then perform a comparative evaluation of the adaption models, with the selection of a best-performing model, selecting the one with the highest score M_{best}^{Z}. Finally, the method 1200 may comprise deployment of that model as the bootstrapped M_{Z} model of edge node 1214 Z.

### D. Further Discussion

As is apparent from this disclosure, one or more example embodiments may possess one or more useful aspects and features, although no embodiment is required to possess any of such useful aspects and features. Following are some illustrative examples.

An embodiment may comprise a method for the orchestration of federated dataset distillation, leveraging a specialized robust aggregation to generate multiple robust distilled datasets. An embodiment may leverage multiple robust distilled datasets for domain adaptation of a baseline model at a newly deployed edge node, and selecting the most fitting model for deployment. An embodiment may yield a number of distilled datasets, each from a subset of the edge nodes, and with characteristics of generality, for that set of edge nodes, and coherence with respect to drift, malicious attacks or other deviations. An embodiment may be privacy-preserving in that all operations of one example method ensure that no data from an edge node is accessible from other nodes or by central node. An embodiment may implement centralized processing, such as at a central node, with minimal processing costs imposed one the edge nodes, with the possible exception of the target node. Finally, an embodiment may ensure robustness for the bootstrapping of a model at a target node.

### E. Example Methods

It is noted with respect to the disclosed methods, including the example method of FIGS. 1-12, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. A method, comprising: by a central node configured to communicate with edge nodes, determining subsets of the edge nodes; by the central node, splitting a distillation process for each of the subsets of the edge nodes to generate distilled datasets; by the central node, leveraging the distilled datasets to adapt a base machine learning (ML) model for use at a newly deployed edge node that lacks adequate data to adapt the base ML model; and deploying, by the central node, the base ML model, after adaptation, to the newly deployed edge node.

Embodiment 2. The method as recited in any preceding embodiment, wherein adapting the base ML model comprises choosing an adaptation to be applied to the base ML model using one of the distilled datasets, and the adaptation is that which most benefits, as among other possible adaptations, the ML base model.

Embodiment 3. The method as recited in any preceding embodiment, wherein the splitting comprises performing a federated dataset distillation process to generate the distilled datasets, and each of the distilled datasets is associated with a respective one of the subsets of the edge nodes.

Embodiment 4. The method as recited in any preceding embodiment, wherein privacy of data respectively associated with the edge nodes is maintained at all times.

Embodiment 5. The method as recited in any preceding embodiment, wherein a robust aggregation process is performed, for each of the subsets, to generate an update for the distilled dataset corresponding to that subset.

Embodiment 6. The method as recited in any preceding embodiment, wherein the splitting is performed based on loss values obtained by evaluation of candidate ML models at the nodes, and the base ML model is one of the candidate ML models.

Embodiment 7. The method as recited in embodiment 6, wherein each of the subsets is associated with a respective candidate ML model.

Embodiment 8. The method as recited in embodiment 6, wherein a learning rate is determined for each of the candidate ML models.

Embodiment 9. The method as recited in embodiment 6, wherein a first structure is employed to annotate relations between edge nodes and subsets, and a second structure is employed to track relations between the candidate ML models and the edge nodes.

Embodiment 10. The method as recited in embodiment 6, wherein each of the distilled datasets is used to train one or more of the candidate ML models.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

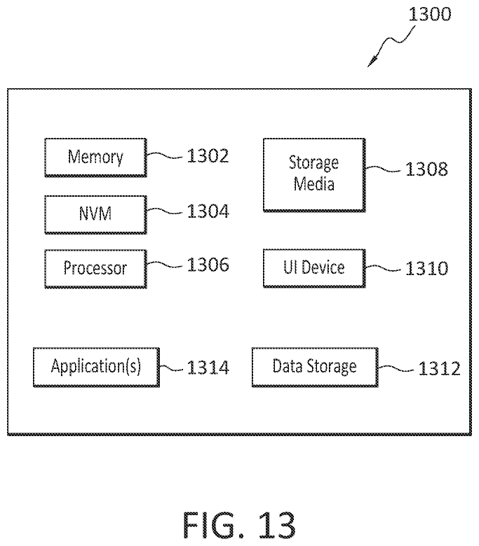

With reference briefly now to FIG. 13, any one or more of the entities disclosed, or implied, by FIGS. 1-12, and/or elsewhere herein, may take the form of, or include, or be implemented on, or hosted by, a physical computing device, one example of which is denoted at 1300. As well, where any of the aforementioned elements comprise or consist of a virtual machine (VM), that VM may constitute a virtualization of any combination of the physical components disclosed in FIG. 13.

In the example of FIG. 13, the physical computing device 1300 includes a memory 1302 which may include one, some, or all, of random access memory (RAM), non-volatile memory (NVM) 1304 such as NVRAM for example, read-only memory (ROM), and persistent memory, one or more hardware processors 1306, non-transitory storage media 1308, UI device 1310, and data storage 1312. One or more of the memory components 1302 of the physical computing device 1300 may take the form of solid state device (SSD) storage. As well, one or more applications 1314 may be provided that comprise instructions executable by one or more hardware processors 1306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
by a central node configured to communicate with edge nodes, determining subsets of the edge nodes;
by the central node, splitting a distillation process for each of the subsets of the edge nodes to generate distilled datasets;
by the central node, leveraging the distilled datasets to adapt a base machine learning (ML) model for use at a newly deployed edge node that lacks adequate data to adapt the base ML model; and
deploying, by the central node, the base ML model, after adaptation, to the newly deployed edge node.

2. The method as recited in claim 1, wherein adapting the base ML model comprises choosing an adaptation to be applied to the base ML model using one of the distilled datasets, and the adaptation is that which most benefits, as among other possible adaptations, the ML base model.

3. The method as recited in claim 1, wherein the splitting comprises performing a federated dataset distillation process to generate the distilled datasets, and each of the distilled datasets is associated with a respective one of the subsets of the edge nodes.

4. The method as recited in claim 1, wherein privacy of data respectively associated with the edge nodes is maintained at all times.

5. The method as recited in claim 1, wherein a robust aggregation process is performed, for each of the subsets, to generate an update for the distilled dataset corresponding to that subset.

6. The method as recited in claim 1, wherein the splitting is performed based on loss values obtained by evaluation of candidate ML models at the nodes, and the base ML model is one of the candidate ML models.

7. The method as recited in claim 6, wherein each of the subsets is associated with a respective candidate ML model.

8. The method as recited in claim 6, wherein a learning rate is determined for each of the candidate ML models.

9. The method as recited in claim 6, wherein a first structure is employed to annotate relations between edge nodes and subsets, and a second structure is employed to track relations between the candidate ML models and the edge nodes.

10. The method as recited in claim 6, wherein each of the distilled datasets is used to train one or more of the candidate ML models.

11. A non-transitory storage medium having stored therein instructions that are executable by one or more hardware processors to perform operations comprising:
by a central node configured to communicate with edge nodes, determining subsets of the edge nodes;
by the central node, splitting a distillation process for each of the subsets of the edge nodes to generate distilled datasets;
by the central node, leveraging the distilled datasets to adapt a base machine learning (ML) model for use at a newly deployed edge node that lacks adequate data to adapt the base ML model; and
deploying, by the central node, the base ML model, after adaptation, to the newly deployed edge node.

12. The non-transitory storage medium as recited in claim 11, wherein adapting the base ML model comprises choosing an adaptation to be applied to the base ML model using one of the distilled datasets, and the adaptation is that which most benefits, as among other possible adaptations, the ML base model.

13. The non-transitory storage medium as recited in claim 11, wherein the splitting comprises performing a federated dataset distillation process to generate the distilled datasets, and each of the distilled datasets is associated with a respective one of the subsets of the edge nodes.

14. The non-transitory storage medium as recited in claim 11, wherein privacy of data respectively associated with the edge nodes is maintained at all times.

15. The non-transitory storage medium as recited in claim 11, wherein a robust aggregation process is performed, for each of the subsets, to generate an update for the distilled dataset corresponding to that subset.

16. The non-transitory storage medium as recited in claim 11, wherein the splitting is performed based on loss values obtained by evaluation of candidate ML models at the nodes, and the base ML model is one of the candidate ML models.

17. The non-transitory storage medium as recited in claim 16, wherein each of the subsets is associated with a respective candidate ML model.

18. The non-transitory storage medium as recited in claim 16, wherein a learning rate is determined for each of the candidate ML models.

19. The non-transitory storage medium as recited in claim 16, wherein a first structure is employed to annotate relations between edge nodes and subsets, and a second structure is employed to track relations between the candidate ML models and the edge nodes.

20. The non-transitory storage medium as recited in claim 16, wherein each of the distilled datasets is used to train one or more of the candidate ML models.
